(19) United States
(12) Patent Application Publication
(10) Pub. No.: US 2015/0364049 A1
(43) Pub. Date: Dec. 17, 2015

(54) Method and system for computer-assisted collaboration, self-correction and peer assessment in education

(71) Applicant: James Alexander Smith, Grouville (JE)

(72) Inventor: James Alexander Smith, Grouville (JE)

(73) Assignee: SCHOOLSHAPE LIMITED, Grouville (JE)

(21) Appl. No.: 14/301,363

(22) Filed: Jun. 11, 2014

(51) Int. Cl. G09B 5/12

(52) U.S. Cl. CPC G09B 5/12

(57) ABSTRACT

A method and system for computer-assisted collaboration, self-correction and peer assessment in education is provided. The method provides students with the opportunity to learn from their mistakes through inductive self-correction, such as would be provided by one-on-one teaching, without requiring a large investment of time from a teacher by using a computer algorithm to provide self-correction hints. Both human teachers and computer algorithms mark sections of the student's response to an educational activity as requiring improvement, and set constraints that the improved work should satisfy. Another algorithm then provides hints which lead the student through a process of improving their response until it meets the given constraints. Practical measures allowing for students to act as teachers for each other through peer assessment are also provided.

### BACKGROUND

The present invention relates generally to the field of computer-assisted education and in particular to assessment and error correction methods in the context of education. It has been recognised that one-on-one teaching is more effective than one-to-many teaching, though prohibitively costly in most cases. Much of the benefit of one-on-one teaching may accrue from the ability of the teacher to lead the student through a process of inductive self-correction, which helps students to understand the concepts behind the work they are doing [1]. Excellent teachers will, rather than supply the answer to any given question, will ask further questions and give clues to guide the student in finding the answer for themselves. This process results in stronger retention and greater understanding of the subject material for the student. This is however, much more time-consuming for the teacher than simply giving the student the correct answer, often prohibitively so. Some innovative educators have attempted to solve this problem through peer assessment [2], where students who understand the material can teach others who have not yet grasped it. This is an excellent motivator for the students, and can be very effective when used carefully. However, it can be ineffective when used inappropriately, because students have neither the necessary training or motivation to lead their peers through inductive self-correction. They may also fail to treat their peers sensitively when assessing each others' work, and the logistics of peer assessment are difficult to manage.

### DESCRIPTION OF RELATED ART

Generalized real-time collaboration systems based on operational transformation [3], such as Google Docs and Microsoft Office 365 are in current use in education, but as yet few such systems have been designed specifically for education.

There are many varied educational systems in use, including networked systems which allow teachers to add correction to the students' responses, single-user systems which reveal a correct answer piecemeal to students if they are unable to find it themselves, and peer assessment systems which allow students to comment on and assess each others' responses.

### BRIEF SUMMARY OF THE INVENTION

The invention disclosed herein aims to solve the problems described above by shifting many of the time-consuming aspects of inductive teaching to a computer, and providing a framework which makes peer assessment practical in a wider range of situations.

In the method provided, one or more students work together on a response to an educational activity along with one or more assessors through interaction with a system using devices connected over a network. Assessors may be professional teachers or may be other students in a peer assessment scenario. The assessors may add a correction to the students' response, which marks a section of the response as requiring improvement and specifies constraints which an improved response should meet. The constraints can in most cases be interpreted by the system and are not immediately revealed to the students. The students may then modify their response to attempt to meet the constraints, and if they are unable to immediately do so, the system will select appropriate hints for the students to help them in moving towards an understanding the material and thus finding an acceptable answer.

Further provisions which make peer assessment practical are provided. To motivate students to help each other, a reputation system is linked which awards points to students for certain actions. If a student disagrees with the constraints, he may challenge them. If the challenge is accepted, and the constraint modified with the agreement of both parties, both student and assessor may earn points. In this way, students are motivated to find accurate corrections in each others' work, able to reject erroneous corrections to their own work, and are motivated to remove or correct erroneous corrections which they have added to others' work.

A second artificial intelligence engine continuously monitors all student responses, and acts as an additional assessor on each one to add corrections where the engine is highly confident that an error exists and that it is able to construct suitable constraints, such as for errors of spelling and grammar.

Students and assessors each work from a computing device which is connected intermittently to a central server where the artificial intelligence engines reside. A real time conflict resolution system based on operational transformation is employed to allow more than one student and assessor to simultaneously interact with the same response, and to continue their interaction in a single-user fashion when they are disconnected from the central server.

### BRIEF DESCRIPTION OF THE DRAWINGS

The disclosure will provide details in the following description of preferred embodiments with reference to the following figures wherein:

FIG. 1 is a block/flow diagram showing a system/method for transforming a student response by modifying its content, adding and modifying corrections, and challenging those corrections; and

FIG. 2 is a block/flow diagram showing a system/method for incentivising assessors and students to behave appropriately by awarding and removing reputation points based on their behaviours.

### DETAILED DESCRIPTION OF THE INVENTION

We describe below a system which is an exemplary embodiment of the claimed system which enables application of the claimed method.

The system is comprised of a database, a server, at least one processing device and a plurality of user input devices connected intermittently via a network.

Users (teachers and students) may identify themselves to the server by logging in from their devices, and may create groups which are stored in the database. The creator of a group may issue an invitation to other users, who can join the group on receiving the invitation, such as is well known in the art.

Users may then select or create an educational activity, and a response is created and stored in the database for each user that interacts with that activity. An educational activity comprises at least one of a textual input and instructions, an image, an audio recording, a video or an animation. A response may be textual, audio, video, or be a selection from a list. A user may have a role of student or of assessor in respect to any one response. A user with the role of student may modify the response, and submit the response for assessment once corrections have been added. A user with the role of assessor may add corrections to the response and modify them. The role of creator of the response is that of a student. Any user may issue invites to another user, which will grant them a certain access to one of the user's responses, groups and/or other data depending on the type of invite. The invite consists of an electronic code which is stored along with the access rights to be granted in the database. The invite may then be transmitted to another user electronically via email or a social network, physically by printing out the code as alphanumeric characters or as a barcode, or by displaying it on a screen. Once the intended recipient receives the code and logs onto the system, it can be redeemed by the server for the corresponding access rights granted by the inviter.

A user may invite another to ‘Team up’, and if this invitation is accepted, the responses of the two users will be merged and they will be collaborating on the same activity together, both in the role of students.

A user may submit his response for assessment to another user, which is equivalent to issuing an invite the other user to become an assessor for his response, and if the invitation is accepted the invited user gains the right to view and modify the response in the role of an assessor.

After the above processes have been carried out, we have at least one student and at least one assessor simultaneously modifying the student's response to an educational activity. The assessor may be a professional teacher, or may be one of the student's peers acting in a peer assessment capacity. The states of the response on the two student devices and the server are kept in synchrony by sending the operations which transform the response between devices and applying them to the local representation of the response on the device. If modifications are made from different devices before they can be applied at other devices, they are processed using operational transformation [1] before being applied so all devices are kept in synchrony and allowing all devices to make changes to a response simultaneously even when intermittently connected to the network. This is achieved by representing student responses as JSON data and modifications as updates, array splices and string splices at certain paths within the JSON data. The full history of operations on the response are stored in the database.

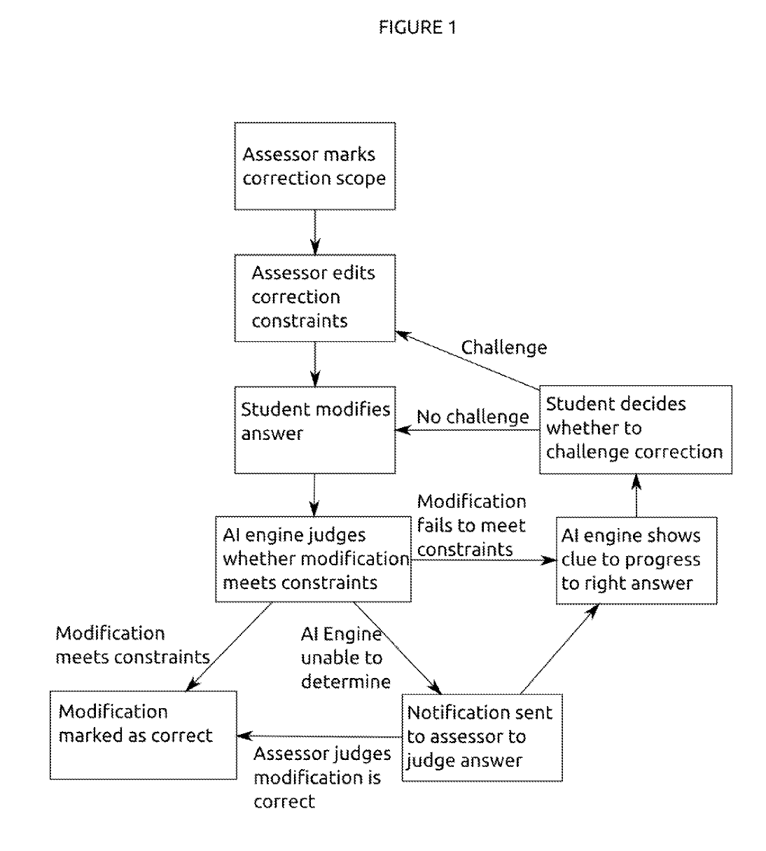

Below we disclose the process of adding a correction to a student's response, which is illustrated in FIG. 1.

When the teacher notices something about the student's response which requires improvement, he adds a correction. This correction may be scoped to part of the student's response (a span of text, length of audio or video for example), or may apply to the whole response. The correction also includes one or more constraints which the modified answer should satisfy. The constraint may be a logical statement about the response (eg: “Photosynthesis does not take place in the nucleus!”), an exemplary replacement response, a requirement on the length or level of vocabulary used in the answer or some other constraint parsable by the system. This constraint is not shown to the student as would be the case in traditional methods of correction.

Instead, the scope of the correction is displayed to the student (for example by highlighting the erroneous section of text in red), and the student should attempt to modify it to meet the unknown constraint. In some cases, simply highlighting the scope of the correction will be enough for the student to realize what he needs to do, and to produce an answer which meets the constraints. In other cases, he may need some help, which is provided in an ever increasing quantity by the system each time he submits an unacceptable modification. In this manner, the student is gradually led to the answer, allowing him to understand his error and how to correct it. The only investment of time and skill required from the assessor is that needed to recognize and mark the error. Further, the assessor is informed that the student has self-corrected the error and that he now understands it. When the assessor is another student, he is only required to know how to spot and correct an error, and not to have the ability and sensitivity to teach the other student.

We below disclose forms of student responses, their corresponding forms of correction constraints and machine-generated clues which an exemplary system should include.

For a textual response with a grammar, spelling or simple factual error there are usually a small number of possible correct responses. The assessor should specify one or more of these correct responses. When a student submits an incorrect attempt, the system will use the Damerau-Levenshtein distance [4] between the student's answer and the correct answers to determine the nearest correct answer, and modify the student's answer to make it one step closer to the correct answer as a hint.

For a textual response with a factual or logical error, the assessor can specify at least one logical statement which contradicts the textual response. On receiving an attempt, the system checks for logical contradictions between the answer and constraints using natural language processing and a constraint solver as is known in the art [5]. If it finds none, the response is marked as correct. If a contradiction still exists, the system will offer hints by rephrasing parts of the constraints as questions. For example, a response may erroneously state “Photosynthesis takes place in the nucleus”, the constraint may state “Photosynthesis takes place only in the chloroplast!” and the system may display a leading question produced by rephrasing a logical constraint using natural language processing (‘Where does photosynthesis take place?’), or reveal a portion of an exemplary response.

For a textual response with significant logical or factual errors, the assessor can specify at least one exemplary answer, which can be selected from a list of answers supplied by the system from answers dealing with similar topics selected from the database. On receiving an attempt, the system analyses the response and the exemplary response, breaking them down into logical statements and combining synonyms using natural language processing [5]. If more than 25% of the logical statements in the exemplary response are also present in the modified response, and there is no logical inconsistency between the modified response and the exemplary response, the modified response is judged acceptable. If the student is unable to produce an acceptable response, the system supplies hints by phrasing portions of the logical statements in the exemplary answer as questions. For example, the exemplary answer may contain “The dissolution of the monasteries was a significant factor in the deterioration of relations between the Catholic church and the English Monarchy”. An answer which expressed a similar logical expression such as “Breaking up the monasteries made the relationship between the Catholic church and England worse” would be acceptable because it reduces to the same logical statement, and an unacceptable answer may be hinted with questions such as “What was a significant factor in the deterioration of the relationship between the Catholic church and the English monarchy?” or “What was the dissolution of the monasteries a significant factor in?”

For a textual response with subjective or stylistic error, the assessor can specify an exemplary answer which they can enter themselves or select from a list of similar previous answers extracted from the database. As the system is unable to judge the acceptability of arbitrary modifications provided by the student, it asks the student to select the words of the exemplary answer from several options with extra antonyms added for key terms to increase the difficulty of the exercise.

For a textual response which fails to mention a key item, a constraint can be added to mention this item or a synonym, and if a student is unable to guess immediately what should be included, parts of the key item can be revealed piecemeal.

For an audio or video response with an error of pronunciation, the assessor can provide an exemplary pronunciation which the student must imitate. The exemplary pronunciation is directly played to the student. The system can judge the correctness of the modified response by comparing it to the exemplary pronunciation using automated prosody analysis [6].

For an audio or video response with grammatical, factual, logical, stylistic or subjective errors, the same processes as for textual responses can be applied by using a speech-to-text engine.

In the case that the system cannot judge the correctness of modification, it may defer to the assessor.

For at least grammatical and spelling errors, a processor within the system will act as an assessor, adding corrections to avoid the assessor having to take care of this arduous task. In these cases, the constraint will be that the response is modified to be grammatically correct, and hints to the nearest correct sentence as measured by Damerau-Levenshtein distance [4] will be supplied if the student is initially unable to supply this. In this way, a student who makes a spelling or grammatical error will first have the opportunity to rephrase his answer, and if he is unable to do so with correct grammar and spelling, will have hints supplied to remedy the situation without limiting the student to a single correct answer. This function is vital for work assessed by the assessor as having to make grammar and spelling corrections for many students would be arduous.

Another way to reduce the workload of the assessor and to increase motivation and engagement among students is peer assessment. Here, however, additional controls are needed to ensure the quality of corrections is kept high. The principle means of shaping motivation in peer assessment is a reputation score. Reputation is accrued through taking desirable actions in the system, attaining higher levels of points enables more access rights within the system and reputation is displayed publicly.

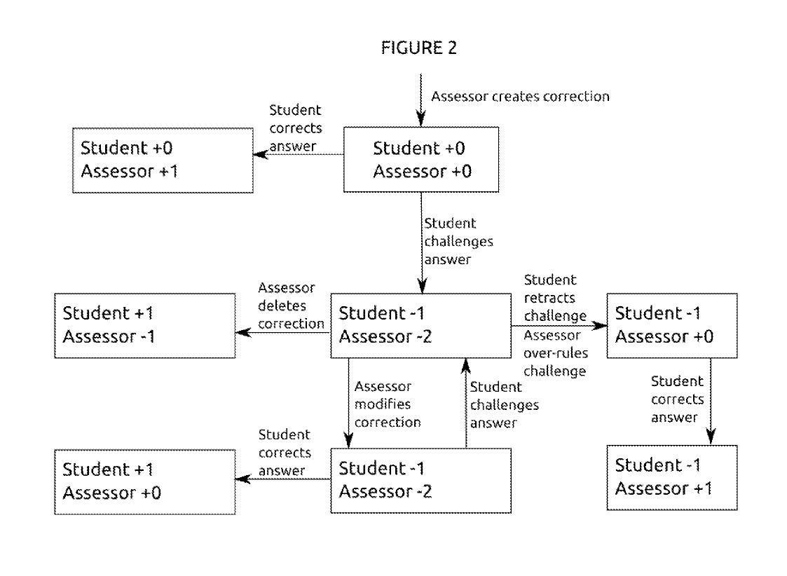

To take account of the fallibility of students when correcting each other's work, a ‘challenge’ system is envisaged. If a student feels that a correction has been added to his work in error, he may challenge it, inviting the assessor to modify or remove the correction. In order to motivate assessors to add corrections appropriately and assessees to avoid spurious challenges, the following scheme is provided, illustrated by FIG. 2, in which bonuses to reputation are denoted by positive numbers, and penalties by negative numbers:
making a correction to a student's work results in a reputation bonus for the assessee when the correction is completed;
making a challenge to a correction gives an immediate reputation penalty, but will result in a overall bonus if the assessor then alters the correction and the correction is completed;
making a correction which is challenges results in a reputation penalty which is removed if the correction is altered and later corrected, and reduced if the correction is deleted; and
if the student and assessor are unable to come to agreement on a correction, they will both be penalized until such time as they do so.

A further provision for increasing the quality of peer assessment is ratings. Once a piece of work has been finished and all corrections completed or deleted, the assessee will be awarded a small amount of reputation, and the opportunity to award a reputation bonus to the assessor depending on how helpful he was during the correction process.

Further, the number and scope of corrections that can be added to students' work is limited according to the reputation of the assessee. This prevents the correction process from being dispiriting for the assessee, and since assessors can only gain reputation from corrections that are successfully completed, knowing that only a limited number can be added will cause them to choose corrections which they feel the assessee is capable of completing.

During the correction process, the participants may discuss the issues using a one-to-one text messaging facility provided by the system as is well known in the art. To avoid the use of such a facility to cheat, all messages received and sent by a student during the course of writing a response are stored in the database and displayed to all assessors of that response.

Because any one peer may not be reliably available to do assessment, it may be desirable to allow any user within a certain group to assess a response. In this case, a user may submit his response to a group rather than to an individual, and any individual within the group may take the role of assessor for the student's response. The student may submit his work anonymously if there is a risk of bias in assessment, so that assessors do not know the identity of the student. In other cases, such as submitting work to a language learning exchange partner for assessment, anonymity is not desired, as the intercultural relationship building aspect of the activity is a significant motivator for students. More than one assessor may add corrections to the student's work.

### REFERENCES CITED

US Patent Documents

| | | |
|---|---|---|
| 6,690,913 | Feb. 10, 2004 | Makishima et al. |
| 6,947,914 | Sep. 20, 2005 | Bertrand et al. |
| 7,558,853 | Jul. 7, 2009 | Acorn et al. |
| 2010/0291528 | Nov. 18, 2010 | Huerta |
| 2011/0065082 | Mar. 17, 2011 | Gal et al. |
| 2013/020492 | Oct. 10, 2013 | Fujisaki |
| 2013/0309647 | Nov. 21, 2013 | Ford et al. |
| 8,682,241 | Mar. 25, 2014 | Huerta |

Foreign Patent Documents

| | | |
|---|---|---|
| 1535392 | Jun. 1, 2005 | EP |
| 2667340 | Nov. 27, 2013 | EP |
| 2696324 | Feb. 12, 2014 | EP |

### Non-Patent Citations

1. Taka-Yoshi Makino, “Learner self-correction in EFL written compositions”, ELT J (1993) 47 (4): pages 337-341.
2. Keith Topping, “Peer Assessment Between Students in Colleges and Universities”, Review of Educational Research Fall 1998 vol. 68 no. 3 pages 249-276.
3. Chengzheng Sun et al. “Operational transformation in real-time group editors: issues, algorithms, and achievements”, Proceedings of the 1998 ACM conference on Computer supported cooperative work, pages 59-68.
4. Vladimir I. Levenshtein. “Binary codes capable of correcting deletions, insertions, and reversals”, Soviet Physics Doklady, 1966.
5. F. Bannay et al, “Using a SMT solver for risk analysis: detecting logical mistakes in procedural texts”, Rapport de recherche, RR-2014-05-FR, IRIT, may 2014.
6. Paul Christopher Bagshaw, “Automatic Prosodic Analysis for Computer Aided Pronunciation Teaching”, 1994.

1. A method of education wherein a student response in the context of an educational activity is transformed by at least one student and at least one assessor, comprising the steps of:
at least one student creates a response;
at least one assessor marks at least one section of the at least one student's response as requiring improvement;
the at least one assessor adds at least one constraint which an improved response should satisfy;
the section requiring improvement is revealed to the at least one student but the constraints are not revealed to the at least one student;
the at least one student modifies their response with the goal of satisfying the constraints;
the at least one student's modifications are received at a response processor;
the response processor, taking as input the at least one student's original answer, the constraints and the at least one student's modification to their response, produces either a judgement that the modification is consistent with the constraints or a judgement that the modification is inconsistent with the constraints and a hint for display to the at least one student; and
the result produced by the processor is revealed to the at least one student, who may further modify his answer and submit it to the processor until the answer is judged consistent with the constraints by the processor or the at least one assessor retracts the constraints.

2. The method of claim 1, wherein the student response is textual or convertible to text, the constraints are comprised of at least one exemplary answer, the modification is consistent with the constraints when it is equal to one exemplary answer, and the hint is a partially revealed exemplary answer.

3. The method of claim 1, wherein the student response is textual or convertible to text, the constraints are comprised of at least one exemplary answer, the modification is consistent with the constraints when the size of the union of the set of logical statements expressed by the modification and the set of logical statements expressed by the exemplary answer is greater than a selected number, and the hints are re-phrasings of parts of the exemplary answer as questions.

4. The method of claim 1, wherein the student response is textual or convertible to text, the constraints are comprised of logical statements which are inconsistent with the student response, the modification is consistent with the constraints when it is not logically inconsistent with the logical statements of which the constraints are comprised and the hints are re-phrasings of parts of the constraints as questions.

5. The method of claim 1, wherein the student response is comprised of audio, the constraint is comprised of an exemplary audio recording, the modification is consistent with the constraints when it is morphologically similar to the exemplary recording, and the hint is a playing of the exemplary recording to the student.

6. The method of claim 1, wherein the constraint is comprised of a subjective statement and the modification is consistent with the constraint when judged to be so by an assessor.

7. The method of claim 1, wherein the assessor is an algorithm running on a processor, the student response is textual and the constraints are that the student response should be composed using correct spelling and grammar.

8. The method of claim 1, further comprising the steps of:
the at least one student challenges the constraint set by the assessor; and
the at least one assessor modifies the constraint, where the modification is at least one of replacing the constraint, deleting the constraint and rejecting the challenge.

9. The method of claim 8, wherein a reputation system is used to incentivise appropriate application of constraints and issuance of challenges.

10. The method of claim 1, wherein a plurality of students and assessors may simultaneously modify the student response and attached constraints in real time.

11. The method of claim 10, wherein simultaneous modification of the student response is implemented using a conflict resolution system based on operational transformation.

12. The method of claim 1, wherein a student may invite another student to concurrently edit the response.

13. The method of claim 1, wherein a student may invite an assessor to assess his work.

14. The method of claim 1, wherein a student may issue an assessment invite to a group, resulting in any member of that group being allowed to become an assessor on the student's response.

15. The method of claim 1, wherein two groups of students with different primary languages who are learning each other's primary languages act as assessors for each other's responses.

16. An educational system comprised of:
a plurality of user devices configured to collect modifications to student responses and constraints on student responses, to submit them to the server, to reveal sections requiring improvement to users, to receive modifications from the server, and to display responses to the user;
at least one database which stores at least student responses and user details;
at least one response processor configured to take as input the student's original answer, the constraints and the student's modifications to their response, produce either a judgement that the student's modification is consistent with the constraints or a judgement that the student's modification is inconsistent with the constraints and a hint for display to the student with the aim of helping the student find an answer which is consistent with the constraint; and
at least one server configured to receive modifications to student responses, transform the modifications to remove conflicts; apply the modifications to the responses, send the modifications to the user devices and store the modifications in the database;

17. The system of claim 16, wherein a student response may be simultaneously modified by multiple users, and simultaneous modification of the student response is implemented using a conflict resolution system based on operational transformation.

18. The system of claim 16, wherein the constraints are set by an algorithm running on a processor, the student response is textual and the constraints are that the student response should be composed using correct spelling and grammar.

19. The system of claim 16, wherein a student may invite another user to concurrently edit the student response, and may invite another user to add constraints to his work.

20. The system of claim 16, wherein the database also stores a collection of groups and the users pertaining to each group, the creator of a group may issue invitations to other users to join said group, users may create groups, users may submit work for assessment to a group, and all users pertaining to a group may become assessors for work submitted to that group.
